(19) United States
(12) Patent Application Publication
(10) Pub. No.: US 2026/0188045 A1
(43) Pub. Date: Jul. 2, 2026

(54) SYSTEMS AND METHODS FOR FINGERPRINT SCANNING WITH SMUDGE DETECTION AND CORRECTION

(71) Applicant: Google LLC, Mountain View, CA (US)

(72) Inventors: Firas Sammoura, Dublin, CA (US); James Brooks Miller, Sunnyvale, CA (US)

(21) Appl. No.: 19/133,695

(22) PCT Filed: Dec. 12, 2023
(86) PCT No.: PCT/US2023/083533

§ 371 Date: May 28, 2025

Related U.S. Application Data
(60) Provisional application No. 63/476,982, filed on Dec. 23, 2022.

(51) Int. Cl. G06V 40/12; G06V 10/74; G06V 10/774; G06V 10/98; G06V 40/13; G06V 40/40

(52) U.S. Cl. CPC G06V 40/1335; G06V 10/761; G06V 10/774; G06V 10/993; G06V 40/1306; G06V 40/1376; G06V 40/1388; G06V 40/40

(57) ABSTRACT

An example device includes a display component comprising a fingerprint sensor configured to scan a fingerprint of a finger. The device includes one or more processors operable to perform operations, including detecting, during a fingerprint authentication phase, a motion of the finger. The operations include capturing, by a fingerprint sensor of the display component, fingerprint data associated with the fingerprint, the motion of the finger having caused a smudging of the fingerprint. The operations include reconstructing, based on the motion of the finger and an estimated fingerprint distortion, an unsmudged fingerprint from the fingerprint data. The reconstructing reduces the smudging of the fingerprint to make it detectable by a fingerprint matching component. The operations include detecting the fingerprint by the fingerprint matching component. The detection of the fingerprint comprises matching the reconstructed fingerprint with a stored fingerprint template.

### CROSS-REFERENCE TO RELATED DISCLOSURE

This application claims priority to U.S. Provisional Application No. 63/476,982, filed on Dec. 23, 2022, which is incorporated herein by reference in its entirety.

### BACKGROUND

A display component of a computing device may be configured for fingerprint authentication. Various security related features may rely on fingerprint authentication. For example, fingerprint authentication can be used for secure access to the computing device, such as locking or unlocking the computing device, and/or to one or more applications and programs. Finger movement during image scanning can lead to smudging of the captured image. Fingerprint authentication can become challenging when a scanned fingerprint is smudged.

### SUMMARY

The present disclosure generally relates to a display component of a computing device. The display component may be configured to authenticate a fingerprint. Finger movement during image scanning can lead to smudging of the captured image. A smudged fingerprint may cause the fingerprint detection system to reject the fingerprint, thereby disabling access to the computing device and/or to one or more applications and programs. A fingerprint sensor can capture multiple frames of fingerprint images, and can be configured to reconstruct the fingerprint based on the finger movement, a fingerprint distortion factor, and the multiple captured frames, to create a smudge free fingerprint image. Such an image can be effectively used by the fingerprint detection system to authenticate the fingerprint.

In a first aspect, a device is provided. The device includes a display component. The display component includes a fingerprint sensor configured to scan a fingerprint of a finger. The device also includes one or more processors operable to perform operations. The operations include detecting, during a fingerprint authentication phase, a motion of the finger. The operations further include capturing, by a fingerprint sensor of the display component, fingerprint data associated with the fingerprint, the motion of the finger having caused a smudging of the fingerprint. The operations also include reconstructing, based on the motion of the finger and an estimated fingerprint distortion, an unsmudged fingerprint from the fingerprint data, wherein the reconstructing reduces the smudging of the fingerprint to make it detectable by a fingerprint matching component. The operations additionally include detecting the fingerprint by the fingerprint matching component, wherein the detecting of the fingerprint comprises matching the reconstructed fingerprint with a stored fingerprint template.

In a second aspect, a computer-implemented method is provided. The method includes detecting, by a display component and during a fingerprint authentication phase, a motion of a finger. The method also includes capturing, by a fingerprint sensor of the display component, fingerprint data associated with the fingerprint, the motion of the finger having caused a smudging of the fingerprint, wherein the fingerprint sensor is configured to scan a fingerprint of the finger. The method further includes reconstructing, based on the motion of the finger and an estimated fingerprint distortion, an unsmudged fingerprint from the fingerprint data, wherein the reconstructing reduces the smudging of the fingerprint to make it detectable by a fingerprint matching component. The method additionally includes detecting the fingerprint by the fingerprint matching component, wherein the detecting of the fingerprint comprises matching the reconstructed fingerprint with a stored fingerprint template.

In a third aspect, an article of manufacture is provided. The article of manufacture may include a non-transitory computer-readable medium having stored thereon program instructions that, upon execution by one or more processors of a computing device, cause the computing device to carry out operations. The operations include detecting, by a display component and during a fingerprint authentication phase, a motion of a finger. The operations further include capturing, by a fingerprint sensor of the display component, fingerprint data associated with the fingerprint, the motion of the finger having caused a smudging of the fingerprint, wherein the fingerprint sensor is configured to scan a fingerprint of the finger. The operations also include reconstructing, based on the motion of the finger and an estimated fingerprint distortion, an unsmudged fingerprint from the fingerprint data, wherein the reconstructing reduces the smudging of the fingerprint to make it detectable by a fingerprint matching component. The operations additionally include detecting the fingerprint by the fingerprint matching component, wherein the detecting of the fingerprint comprises matching the reconstructed fingerprint with a stored fingerprint template.

In a fourth aspect, a system is provided. The system includes means for detecting, by a display component and during a fingerprint authentication phase, a motion of a finger; means for capturing, by a fingerprint sensor of the display component, fingerprint data associated with the fingerprint, the motion of the finger having caused a smudging of the fingerprint, wherein the fingerprint sensor is configured to scan a fingerprint of the finger; means for reconstructing, based on the motion of the finger and an estimated fingerprint distortion, an unsmudged fingerprint from the fingerprint data, wherein the reconstructing reduces the smudging of the fingerprint to make it detectable by a fingerprint matching component; and means for detecting the fingerprint by the fingerprint matching component, wherein the detecting of the fingerprint comprises matching the reconstructed fingerprint with a stored fingerprint template.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1 illustrates a computing device for smudge detection, in accordance with example embodiments.

FIG. 2A is an example block diagram depicting fingerprint detection by unsmudging an image, in accordance with example embodiments.

FIG. 2B illustrates example pixel configurations for motion detection, in accordance with example embodiments.

FIG. 2C is an example block diagram depicting fingerprint detection by unsmudging an image using a machine learning model, in accordance with example embodiments.

FIG. 2D is an example block diagram depicting fingerprint detection using a machine learning based matching model, in accordance with example embodiments.

FIG. 2E is an example block diagram depicting fingerprint detection using a machine learning based matching and spoof detection model, in accordance with example embodiments.

FIG. 2F is an example block diagram depicting fingerprint detection by unsmudging an image based on force detection, in accordance with example embodiments.

FIG. 3 is a diagram illustrating training and inference phases of a machine learning model, in accordance with example embodiments.

FIG. 4 depicts a distributed computing architecture, in accordance with example embodiments.

FIG. 5 depicts a network of computing clusters arranged as a cloud-based server system, in accordance with example embodiments.

FIG. 6 illustrates a method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### Overview

Human fingerprints are detailed, nearly unique, and difficult to alter, and durable over lifetime. Fingerprint authentication can be used to enable individuals to gain access to secure devices, locations, and software features, such as, for example, a user device, a door entrance, a vault, an application software, and so forth. During a fingerprint authentication phase, a fingerprint scanner scans a fingerprint and processes the scanned image for validation purposes. A user may place their finger on the fingerprint scanner. However, several factors may cause the scanned image to be smudged. For example, motion blur may be caused by a movement of the finger, a movement of the device, or both. Also, for example, poor lighting conditions may negatively impact the quality of the scanned image. In some situations, pressure exerted by the finger on the scanner may cause the scanned image to be distorted. In some other situations, image compression may cause defects in the scanned image. Also, for example, the finger may be partially scanned due to a placement of the finger relative to the fingerprint scanner.

The scanned image of a fingerprint may be matched to an existing fingerprint template. For example, during a fingerprint enrollment phase, the device may scan several images of the finger. For example, a user may be guided to place the finger at certain locations on the display component, rotate the finger in different directions, at different speeds, with different amounts of pressure, and so forth. Such scanned images may then be stored in a database for the fingerprint authentication phase. During the fingerprint authentication phase, a scanned fingerprint may be compared to a stored fingerprint to determine whether there is a match.

Traditional matching approaches are based on fine characteristics of a fingerprint. Such approaches are challenging to implement in situations where small and/or partial fingerprint images are available. Some conventional techniques rely on Scale Invariant Feature Transform (SIFT) pattern matching. This has limited extracted features, and a latency associated with this approach cannot be optimized with hardware acceleration.

A fingerprint scanner on a device can be configured with an ability to detect finger movement. Various sensors, such as an optical sensor, an ultrasonic sensor, a direct pressure sensor, a capacitive sensor, a thermal sensor, and so forth can be used. Generally, a fingerprint may not be stable on the device, and the device may fail to recognize the fingerprint, thereby stalling or terminating the fingerprint authentication process. For example, finger movement during image scanning can lead to smudging of the captured image. Smudged fingerprints can cause the fingerprint detection system to reject the verification attempt.

Conventional fingerprint scanners are not equipped to detect smudging. In theory, smudging can be fixed with a high frame rate and image stacking. Pixel flow techniques may also be used to estimate a motion of the finger and correct the image. However, these can be resource intensive.

Correction of a smudged fingerprint can involve an understanding of various factors, such as environmental light intensity, variations in individual fingerprints, variations due to display components, variations due to different types of sensors, an amount of motion, a direction of motion, an amount of pressure applied to a display component, temperature changes, and so forth. Accordingly, performing such operations on a mobile device, in near real-time, can be a challenging task. Such a task can be solved by deploying a combination of hardware accelerators, on-device machine learning models, and/or enhanced image processing techniques.

Some techniques described herein address these issues by providing efficient methods to unsmudge a scanned fingerprint, thereby enabling a fast, efficient, and more precise fingerprint authentication process. Also, for example, anti-spoofing techniques can be performed. Such operations may be performed in near real-time, on a mobile device, thereby resulting in a significant improvement in security of the device, data, and applications. Other advantages are also contemplated and will be appreciated from the discussion herein.

### Example Devices

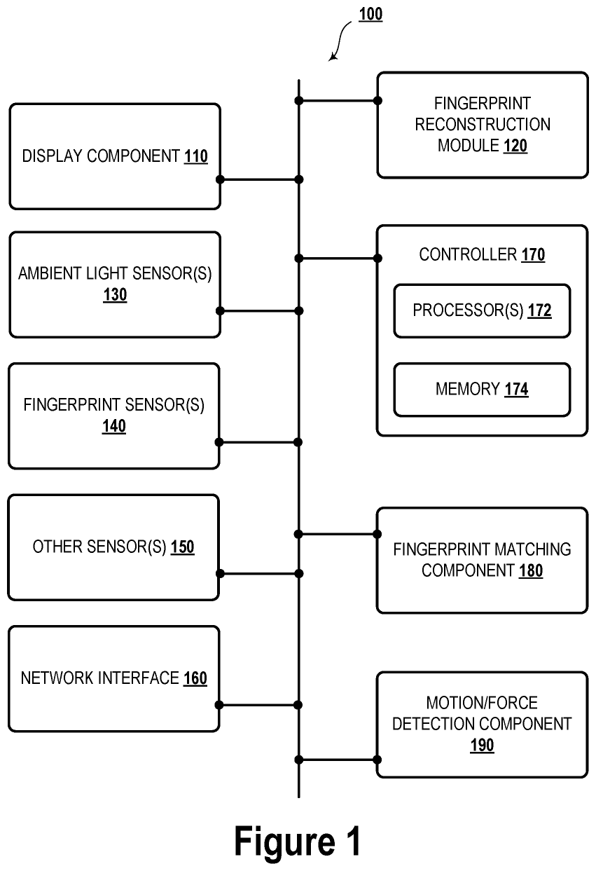

FIG. 1 illustrates computing device 100, in accordance with example embodiments. Computing device 100 includes display component 110, fingerprint reconstruction module 120, one or more ambient light sensors 130, one or more fingerprint sensors 140, one or more other sensors 150, network interface 160, controller 170, fingerprint matching component 180, and motion/force detection component 190. In some examples, computing device 100 may take the form of a desktop device, a server device, or a mobile device. Computing device 100 may be configured to interact with an environment. For example, computing device 100 may obtain fingerprint information from an environment around computing device 100. Also, for example, computing device 100 may obtain environmental state measurements associated with an environment around computing device 100 (e.g., ambient light measurements, etc.).

Display component 110 may be configured to provide output signals to a user by way of one or more screens (including touch screens), cathode ray tubes (CRTs), liquid crystal displays (LCDs), light emitting diodes (LEDs), displays using digital light processing (DLP) technology, and/or other similar technologies. Display component 110 may also be configured to generate audible outputs, such as with a speaker, speaker jack, audio output port, audio output device, earphones, and/or other similar devices. Display component 110 may further be configured with one or more haptic components that can generate haptic outputs, such as vibrations and/or other outputs detectable by touch and/or physical contact with computing device 100.

In example embodiments, display component 110 is configured to operate at a given brightness level. The brightness level may correspond to an operation being performed by the display component. For example, when an under display fingerprint sensor (UDFPS) is activated, display component 110 may operate at a brightness level corresponding to 800 or 900 nits. In example embodiments, display component 110 may operate at a low brightness level corresponding to 2 nits to account for low environmental light intensity. In some other examples, display component 110 may operate at a normal brightness level corresponding to 500 nits.

In certain embodiments, display component 110 may be a color display utilizing a plurality of color channels for generating images. For example, display component 110 may utilize red, green, and blue (RGB) color channels, or cyan, magenta, yellow, and black (CMYK) color channels, among other possibilities.

In some embodiments, display component 110 may include a plurality of pixels disposed in a pixel array defining a plurality of rows and columns. For example, if display component 110 had a resolution of 1024×500, each column of the array may include 500 pixels and each row of the array may include 1024 groups of pixels, with each group including a red, blue, and green pixel, thus totaling 3072 pixels per row. In example embodiments, the color of a particular pixel may depend on a color filter that is disposed over the pixel.

In example embodiments, display component 110 may receive signals from its pixel array. The signals may be indicative of a motion. For instance, a digital image of a fingerprint may contain various image pixels that correspond to respective pixels of display component 110. Each pixel of the digital image may have a numerical value that represents the luminance (e.g., brightness or darkness) of the digital image at a particular spot. These numerical values may be referred to as “gray levels.” The number of gray levels may depend on the number of bits used to represent the numerical values. For example, if 8 bits were used to represent a numerical value, display component 110 may provide 256 gray levels, with a numerical value of 0 corresponding to full black and a numerical value of 255 corresponding to full white.

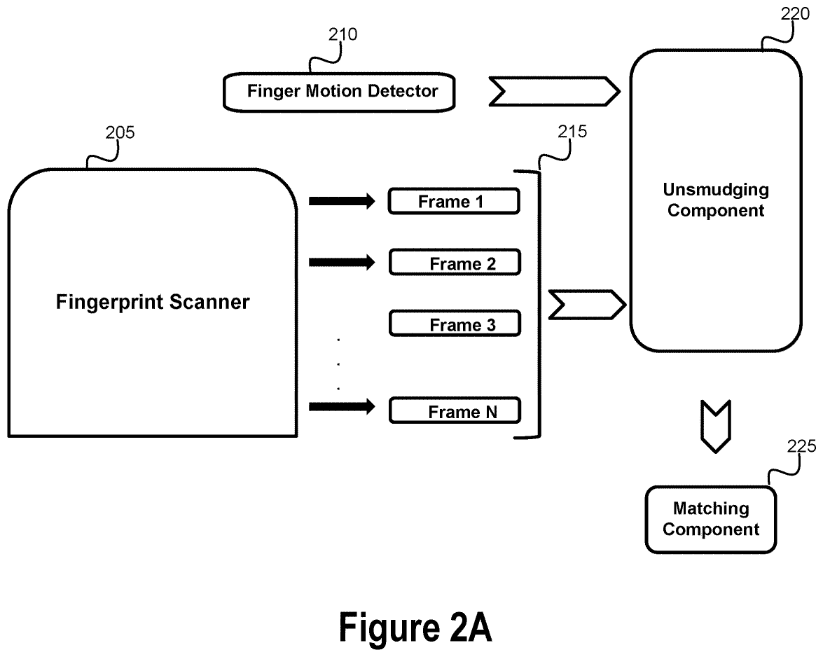

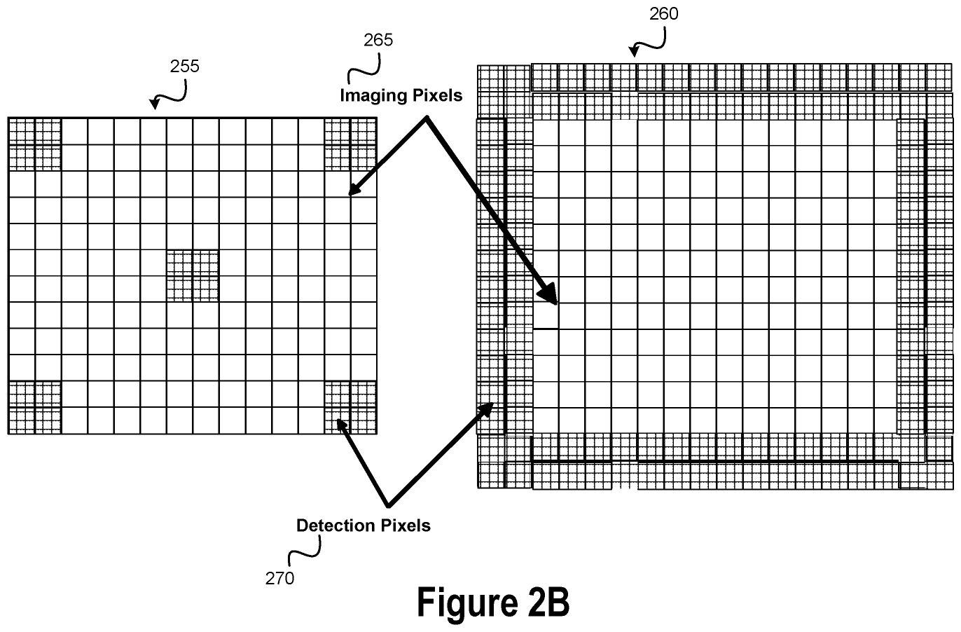

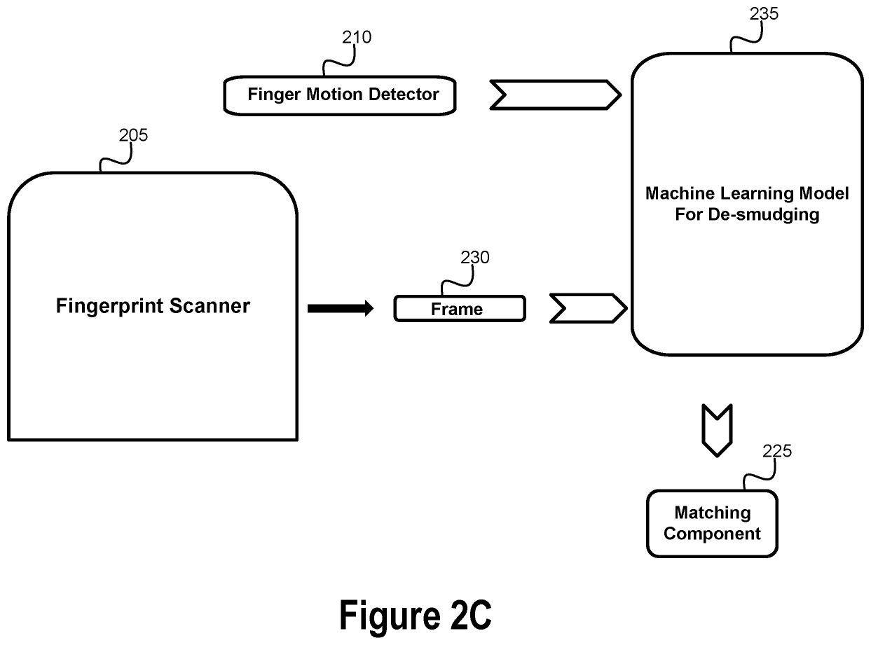

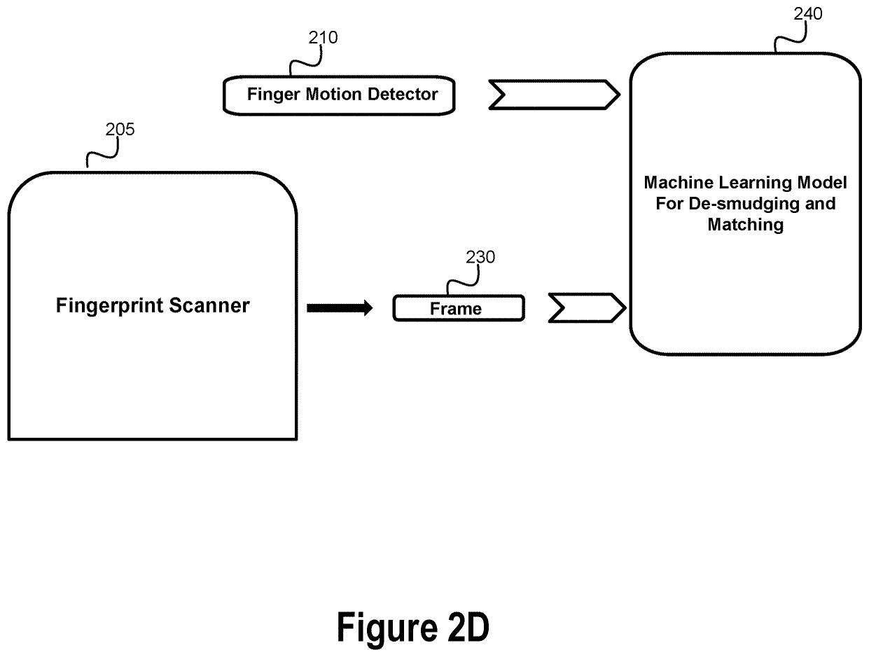

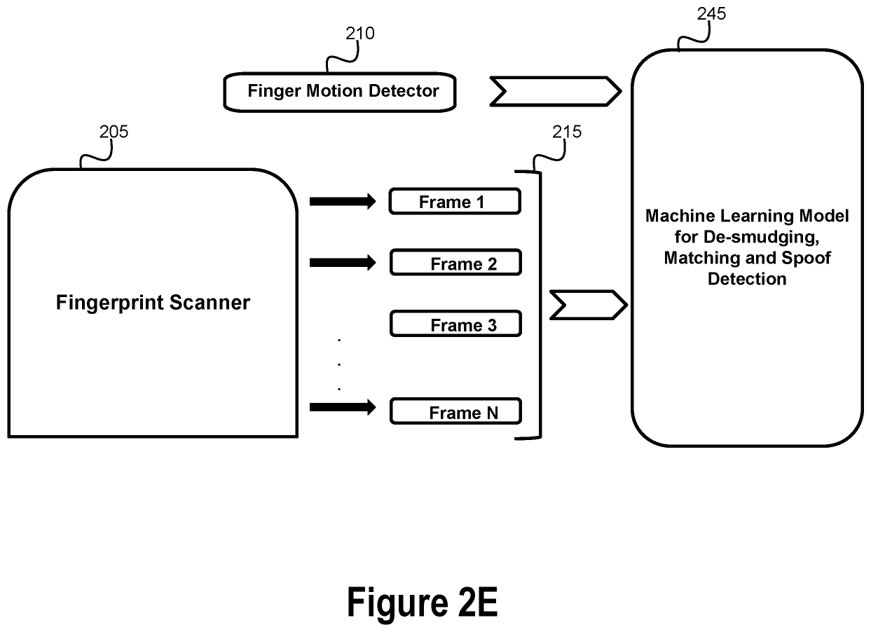

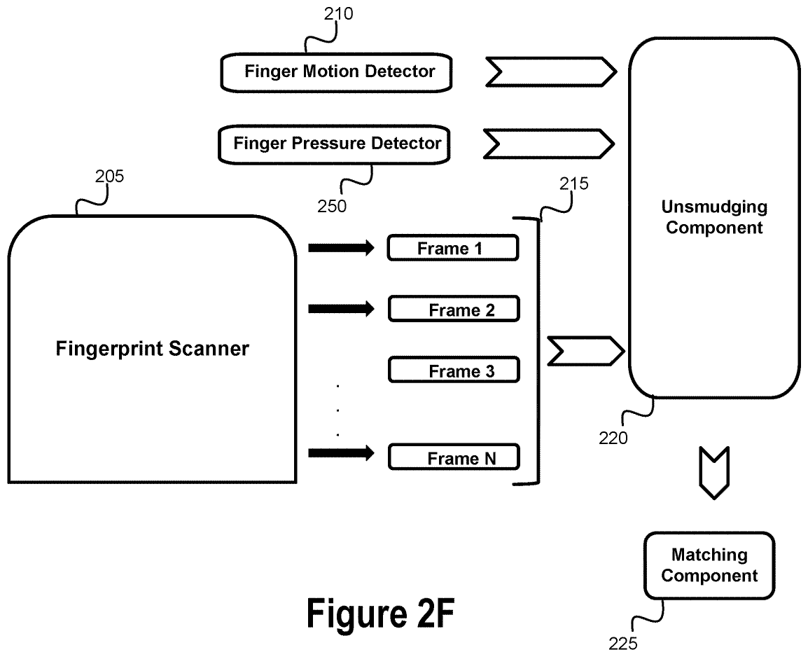

Fingerprint reconstruction module 120 may be configured with logic to compensate for inaccuracies that occur due to an error during fingerprint scanning. For example, a motion of a fingerprint can result in a motion blur in the fingerprint image. Also, for example, a pressure on the display component 110 can result in a smudging of the fingerprint image. Fingerprint reconstruction module 120 can be configured with logic to reconstruct an unsmudged fingerprint image that can be used by a fingerprint matching component. In some embodiments, fingerprint reconstruction module 120 may include one or more machine learning algorithms that perform de-smudging. The fingerprint reconstruction module 120 may share one or more aspects in common with the unsmudging components described herein (e.g., with reference to FIG. 2A-2F).

Ambient light sensor(s) 130 may be configured to receive light from an environment of (e.g., within 1 meter (m), 5 m, or 10 m of) computing device 100. Ambient light sensor(s) 130 may include one or more single photon avalanche detectors (SPADs), avalanche photodiodes (APDs), complementary metal oxide semiconductor (CMOS) detectors, and/or charge-coupled devices (CCDs). For example, ambient light sensor(s) 130 may include indium gallium arsenide (InGaAs) APDs configured to detect light at wavelengths around 1550 nanometers (nm). Other types of ambient light sensor(s) 130 are possible and contemplated herein.

In some embodiments, ambient light sensor(s) 130 may include a plurality of photodetector elements disposed in a one-dimensional array or a two-dimensional array. For example, ambient light sensor(s) 130 may include sixteen detector elements arranged in a single column (e.g., a linear array). The detector elements could be arranged along, or could be at least parallel to, a primary axis.

In some embodiments, computing device 100 can include one or more fingerprint sensor(s) 140. In some embodiments, fingerprint sensor(s) 140 may include one or more image capture devices that can take an image of a finger. Fingerprint sensor(s) 140 are utilized to authenticate a fingerprint. The image of the finger captured by the one or more image capture devices is compared to a stored image for authentication purposes. The light from display component 110 is reflected from the finger back to the fingerprint sensor(s) 140. There may be loss of light emanating from the display, and a loss from a low reflection. A high brightness level is generally needed to illuminate the finger adequately to meet SNR requirements, and avoid the loss from the display, and/or from the reflection. In some embodiments, fingerprint sensor(s) 140 is configured with a time threshold within which the authentication process is to be completed. When the authentication process is not completed within the time threshold, the authentication process fails. In some embodiments, the authentication may fail due to defects in the scanned fingerprint. For example, a smudged fingerprint may not be identifiable. In some embodiments, display component 110 may attempt to re-authenticate the fingerprint. Such repetitive authentication processes can cause a high consumption of power.

Fingerprint sensor(s) 140 can include optical, ultrasonic and/or capacitive sensors. For example, an under display fingerprint sensor (UDFPS) is an optical sensor that is laminated underneath a display component 110 of computing device 100. In order for the USFPS to work during fingerprint authentication, light emitted by the display component 110 is reflected back from a finger to be authenticated, back to the sensor. Generally, the display component 110 may operate at a normal mode that corresponds to a low brightness level. In some embodiments, display component 110 may switch to a high brightness mode to enable fingerprint scanning and detection.

In some embodiments, computing device 100 can include one or more other sensors 150. Other sensor(s) 150 can be configured to measure conditions within computing device 100 and/or conditions in an environment of (e.g., within 1 m, 5 m, or 10 m of) computing device 100 and provide data about these conditions. For example, other sensor(s) 150 can include one or more of: (i) sensors for obtaining data about computing device 100, such as, but not limited to, a thermal sensor for measuring thermal activity at or near computing device 100, a thermometer for measuring a temperature of computing device 100, a battery sensor for measuring power of one or more batteries of computing device 100, and/or other sensors measuring conditions of computing device 100; (ii) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and/or a laser tracker, where the identification sensor can be configured to read identifiers, such as RFID tags, barcodes, QR codes, and/or other devices and/or objects configured to be read, and provide at least identifying information; (iii) sensors to measure locations and/or movements of computing device 100, such as, but not limited to, a tilt sensor, a gyroscope, an accelerometer, a Doppler sensor, a Global Positioning System (GPS) device, a sonar sensor, a radar device, a laser-displacement sensor, and/or a compass; (iv) an environmental sensor to obtain data indicative of an environment of computing device 100, such as, but not limited to, an infrared sensor, an optical sensor, a biosensor, a capacitive sensor, a touch sensor, a temperature sensor, a wireless sensor, a radio sensor, a movement sensor, a proximity sensor, a radar receiver, a microphone, a sound sensor, an ultrasound sensor and/or a smoke sensor; (v) a pressure sensor to measure an amount of pressure applied to display component 110 by a finger during fingerprint enrollment and/or authentication; and/or (vi) a force sensor to measure one or more forces (e.g., inertial forces and/or G-forces) acting about computing device 100, such as, but not limited to one or more sensors that measure: forces in one or more dimensions, torque, ground force, friction, and/or a zero moment point (ZMP) sensor that identifies ZMPs and/or locations of the ZMPs. Many other examples of other sensor(s) 150 are possible as well.

Data gathered from ambient light sensors(s) 130, fingerprint sensor(s) 140, and other sensor(s) 150 may be communicated to controller 170, which may use the data to perform one or more actions.

Network interface 160 can include one or more wireless interfaces and/or wireline interfaces that are configurable to communicate via a network. Wireless interfaces can include one or more wireless transmitters, receivers, and/or transceivers, such as a Bluetooth™M transceiver, a Zigbee® transceiver, a Wi-Fi™ transceiver, a WiMAX™ transceiver, an LTE™ transceiver, and/or other similar types of wireless transceivers configurable to communicate via a wireless network. Wireline interfaces can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some embodiments, network interface 160 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

Computing device 100 can include a user interface module (not shown) that can be operable to send data to and/or receive data from external user input/output devices. For example, the user interface module can be configured to send and/or receive data to and/or from user input devices such as a touch screen, a computer mouse, a keyboard, a keypad, a touch pad, a trackball, a joystick, a voice recognition module, and/or other similar devices. The user interface module can also be configured to provide output to user display devices, such as one or more cathode ray tubes (CRT), liquid crystal displays, light emitting diodes (LEDs), displays using digital light processing (DLP) technology, printers, light bulbs, and/or other similar devices, either now known or later developed. The user interface module can also be configured to generate audible outputs, with devices such as a speaker, speaker jack, audio output port, audio output device, earphones, and/or other similar devices. The user interface module can further be configured with one or more haptic devices that can generate haptic outputs, such as vibrations and/or other outputs detectable by touch and/or physical contact with computing device 100. In some examples, the user interface module can be used to provide a graphical user interface (GUI) for utilizing computing device 100. For example, the user interface module can be used to provide instructions to a user during a fingerprint enrollment phase to guide the user to successfully enroll their fingerprint.

Computing device 100 may also include a power system (not shown). The power system can include one or more batteries and/or one or more external power interfaces for providing electrical power to computing device 100. Each battery of the one or more batteries can, when electrically coupled to computing device 100, act as a source of stored electrical power for computing device 100. The one or more batteries of the power system can be configured to be portable. Some or all of the one or more batteries can be readily removable from computing device 100. In other examples, some or all of the one or more batteries can be internal to computing device 100, and so may not be readily removable from computing device 100. Some or all of the one or more batteries can be rechargeable. For example, a rechargeable battery can be recharged via a wired connection between the battery and another power supply, such as by one or more power supplies that are external to computing device 100 and connected to computing device 100 via the one or more external power interfaces. In other examples, some or all of one or more batteries can be non-rechargeable batteries.

The one or more external power interfaces of the power system can include one or more wired-power interfaces, such as a USB cable and/or a power cord, that enable wired electrical power connections to one or more power supplies that are external to computing device 100. The one or more external power interfaces can include one or more wireless power interfaces, such as a Qi wireless charger, that enable wireless electrical power connections, such as via a Qi wireless charger, to one or more external power supplies. Once an electrical power connection is established to an external power source using the one or more external power interfaces, computing device 100 can draw electrical power from the external power source using the established electrical power connection. In some examples, the power system can include related sensors, such as battery sensors associated with the one or more batteries or other types of electrical power sensors.

Controller 170 may include one or more processors 172 and memory 174. Processor(s) 172 can include one or more general purpose processors and/or one or more special purpose processors (e.g., display driver integrated circuit (DDIC), digital signal processors (DSPs), tensor processing units (TPUs), graphics processing units (GPUs), application specific integrated circuits (ASICs), etc.). Processor(s) 172 may be configured to execute computer-readable instructions that are contained in memory 174 and/or other instructions as described herein.

Memory 174 may include one or more non-transitory computer-readable storage media that can be read and/or accessed by processor(s) 172. The one or more non-transitory computer-readable storage media can include volatile and/or non-volatile storage components, such as optical, magnetic, organic or other memory or disc storage, which can be integrated in whole or in part with at least one of processor(s) 172. In some examples, memory 174 can be implemented using a single physical device (e.g., one optical, magnetic, organic or other memory or disc storage unit), while in other examples, memory 174 can be implemented using two or more physical devices.

Memory 174 can include computer-readable instructions and perhaps additional data. In some examples, memory 174 can include storage required to perform at least part of the herein-described methods, scenarios, and techniques and/or at least part of the functionality of the herein-described devices and networks. In some examples, memory 174 can include storage for a trained neural network model (e.g., a model of trained neural networks such as the networks described herein). Memory 174 can also be configured to store a fingerprint template after enrollment.

In example embodiments, processor(s) 172 are configured to execute instructions stored in memory 174 so as to carry out operations.

The operations may include detecting, by the fingerprint sensor 140 during a fingerprint authentication phase, a motion of the finger.

The operations may also include capturing, by a fingerprint sensor of the display component 110, fingerprint data associated with the fingerprint, the motion of the finger having caused a smudging of the fingerprint.

The operations may further include reconstructing, by the fingerprint reconstruction module 120 and based on the motion of the finger and an estimated fingerprint distortion, an unsmudged fingerprint from the fingerprint data, wherein the reconstructing reduces the smudging of the fingerprint to make it detectable by a fingerprint matching component.

The operations may also include detecting the fingerprint by the fingerprint matching component 180, wherein the detecting of the fingerprint comprises matching the reconstructed fingerprint with a stored fingerprint template.

Fingerprint matching component 180 may be configured with logic that compares a scanned fingerprint with a stored fingerprint template. For example, fingerprint matching component 180 may be configured with logic to identify one or more features of a fingerprint, such as ridges, lines, patterns, valleys, scars, and so forth, and store these features as a fingerprint template. To do this, fingerprint matching component 180 may include memory for storing the one or more features.

Motion/force detection component 190 may include circuitry and/or logic that could identify motion and/or force that is applied to display component 110. For example, motion/force detection component 190 may receive pixel values from an array of pixels and detect motion. Also, for example, motion/force detection component 190 may compute an optical flow based on a plurality of successive image frames, and detect motion based on the optical flow. Also, for example, motion/force detection component 190 may receive data from a thermal sensor and detect motion based on thermal activity. As another example, motion/force detection component 190 may receive data from a pressure sensor and/or a fingerprint sensor to determine an amount of pressure that a finger has applied to display component 110.

FIG. 2A is an example block diagram depicting fingerprint detection by unsmudging an image, in accordance with example embodiments. Some embodiments may involve capturing, by a fingerprint sensor of the display component, fingerprint data associated with the fingerprint, the motion of the finger having caused a smudging of the fingerprint. For example, during the fingerprint authentication phase, fingerprint scanner 205 may capture one or more images of a fingerprint associated with a finger, and generate one or more frames 215, such as, for example, frame 1, frame 2, . . . , frame N.

Fingerprint scanner 205 may include a sensor, such as an optical sensor, an ultrasonic sensor, a direct pressure sensor, a capacitive sensor, a thermal sensor, and so forth. The fingerprint sensor can capture multiple image frames and send them to an internal buffer. In ultrasonic sensors, multiple frames may be captured at specific intervals, and a final image may be reconstructed using a diffraction model.

Accordingly, although the example techniques are described with reference to optical images, this is for illustrative purposes only. For example, image data based on the one or more frames 215 may be substituted with data from a capacitive sensor, a thermal sensor, and so forth.

Finger motion detector 210 may detect a motion of the finger. Generally, the motion of the finger may cause a smudging of the fingerprint. For example, the one or more frames 215 may have motion blur. This may cause the fingerprint data to represent a smudged fingerprint, which may be unreliable for fingerprint authentication. The term “smudge” as used herein may generally refer to an image distortion or degradation that causes an error in the captured fingerprint image, thereby making it difficult to be recognized by a fingerprint detection system. For example, a smudged fingerprint may have a motion blur due to a motion of the finger, the device, or both. Additionally, even in ideal acquisition conditions, there can be an intrinsic blur due to sensor resolution, light diffraction, display aberrations, pixel saturation, and anti-aliasing filters. Similarly, image noise is intrinsic to the capture of an image.

The term “image noise” as used herein, generally refers to a smudging that causes an image to appear to have artifacts (e.g., specks, color dots, and so forth) resulting from a lower signal-to-noise ratio (SNR). For example, an SNR below a certain desired threshold value may cause image noise. In some examples, image noise may occur due to an image sensor. In general, when images are compressed, such as by using JPEG compression, before storage or transmission, such image compression artifacts can also degrade the image quality. The term “image compression artifact” as used herein, generally refers to a degradation factor that results from lossy image compression. For example, image data may be lost during compression, thereby resulting in visible artifacts in a decompressed version of the image.

The term “pixel saturation” as used herein, generally refers to a condition where pixels are saturated with photons, and the photons then spill over into adjacent pixels. For example, a saturated pixel may be associated with an image intensity of higher than a threshold intensity (e.g., higher than 245, or at 255, and so forth). Image intensity may correspond to an intensity of a grayscale, or an intensity of a color component in red, blue, or green (RGB). For example, highly saturated pixels may appear as brightly colored. Accordingly, the spilling over of photons from saturated pixels into adjacent pixels may cause perceptive defects in an image (for example, causing a saturation of one or more adjacent pixels, distorting the intensity of the one or more adjacent pixels, and so forth).

Some embodiments may involve detecting, by a display component and during the fingerprint authentication phase, a motion of the finger. For example, finger motion detector 210 may detect the motion of the finger. In some embodiments, a motion vector representing the motion of the finger may be generated. For example, the displacement between respective pixels in two successive frames in the one or more frames 215 may be represented by a motion vector. Also, for example, one or more feature vectors may be generated for input into the various machine learning models described herein.

In some embodiments, the detecting of the motion of the finger may be based on respective pixel values of one or more pixels in a pixel array of an image of the fingerprint. In some embodiments, the one or more pixels in the pixel array may be dedicated for motion detection. For example, as a finger moves, fingerprint scanner 205 may capture images with different pixel values. The change in the pixel values in the one or more frames 215 reflect the motion and may be processed to detect the motion.

FIG. 2B illustrates example pixel configurations for motion detection, in accordance with example embodiments. Image 255 illustrates an example pixel arrangement where motion detection pixels 270 (represented by white squares) are located at the four corners and the center of the pixel array, while the remaining portion of the pixel array is occupied by imaging pixels 265 (represented by white squares). Image 260 illustrates an example pixel array where motion detection pixels 270 (represented by white squares) are located along the boundaries of the pixel array, surrounding the imaging pixels 265 (represented by white squares) located in the central region of the pixel array. In some embodiments, the one or more pixels in the pixel array may be distributed randomly within the pixel array.

In some embodiments, the detecting of the motion of the finger is performed using an application specific integrated circuit (ASIC) of the device. For example, a Tensor Processing Unit (TPU) may include a single-chip ASIC with dedicated algorithms for motion detection.

In some embodiments, the display component includes a touch sensitive display panel, the fingerprint sensor may be an under display fingerprint sensor (UDFPS), and the method involves determining a heat map indicative of motion at or near the touch sensitive display panel. In some embodiments, the device includes a heat sensor configured to detect thermal activity at or near the device, and the method involves determining a heat map based on the detected thermal activity. In such embodiments, the detecting of the motion of the finger may be based on a heat map. A heat map (or thermal imaging) identifies areas of interest by mapping different thermal properties of the finger to various colors, such as, for example, colors ranging from red to blue. Generally, red, yellow, and orange colors represent regions that have a higher temperature, whereas blue, and green colors represent regions that have a lower temperature. A temporal thermal imaging can enable detection of motion of the finger.

In some embodiments, the fingerprint sensor may be a capacitive fingerprint sensor. The detecting of the motion of the finger may be based on a capacitive region of the display component. Generally, capacitive fingerprint scanners may include an array of capacitor circuits to collect data about a fingerprint. The capacitors store electrical charge which changes when a finger's ridge is placed on a conductive plate of the capacitive sensor. However, the electrical charge is unchanged when there is an air gap. The changes in the electrical charge may be tracked with an integrator circuit and recorded by an analog-to-digital converter (ADC). The captured fingerprint data may be processed to analyze features of the fingerprint. For motion detection, changes in the electrical charges over time may be processed to detect motion of the finger.

In some embodiments, the fingerprint sensor may be an ultrasonic fingerprint sensor. An ultrasonic pulse may be transmitted by the sensor against the finger that is placed on the fingerprint scanner 205. Generally, a portion of the pulse may be absorbed, and another portion may be reflected back to the sensor based on a location and/or configuration of the ridges, valleys, pores, scars, bumps, and other details unique to each fingerprint. In some embodiments, fingerprint data generated by the sensor over time may be processed to detect motion of the finger.

Some embodiments involve determining an optical flow based on one or more images of the fingerprint. The detection of the motion of the finger may be based on the optical flow. For example, the finger may be tracked within the one or more frames 215 to determine motion. Some optical flow techniques may be gradient-based. Generally, a displacement, and/or velocity of the finger motion may be determined using the optical flow. Various methods, such as phase correlation, differential methods (e.g., Lucas-Kanade, Hon-Schunk, Buxton-Buxton, etc.), and/or discrete optimization methods may be used. In some embodiments, the device may include an optical sensor configured to measure optical flow or visual motion of the finger. For example, the optical flow sensor may be communicatively linked to the ASIC that includes one or more algorithms to detect motion based on the optical flow measurements. In some embodiments, neuromorphic circuits may be implemented within an optical sensor to respond to an optical flow.

Some embodiments involve reconstructing, based on the motion of the finger and an estimated fingerprint distortion, an unsmudged fingerprint from the fingerprint data, wherein the reconstructing reduces the smudging of the fingerprint to make it detectable by a fingerprint matching component. For example, unsmudging component 220 may be configured to reconstruct the unsmudged fingerprint from the fingerprint data (e.g., image data from images in the one or more frames 215) based on motion data from finger motion detector 210. The unsmudging component 220 may reduce image distortions caused due to finger motion, sensor resolution, light diffraction, display aberrations, pixel saturation, and/or anti-aliasing filters. Similarly, image noise may be reduced. Artifacts due to pixel saturation and/or compression, may be reduced, and/or removed. Additional and/or alternative image enhancement techniques may be applied to reconstruct the unsmudged image. For example, a brightness correction may be applied to compensate for distortions due to low light settings. In some embodiments, a geometric distortion map may be applied to correct the geometric properties of ridges and valleys in the fingerprint data.

In some embodiments, frame stacking techniques may be used to interpolate the reconstructed fingerprint from the one or more frames 215. Frame interpolation is the process of synthesizing in-between images from a given set of images. The technique may be used for temporal up-sampling. For example, the sensor may capture images at a high frame rate, and frame interpolation may be used to interpolate between these near-duplicate images.

In some embodiments, the estimated fingerprint distortion may be indicative of a baseline amount of smudging. For example, the estimated fingerprint distortion may be based on a normalized amount of smudging based on a plurality of users, a plurality of devices, or both. Some fingerprint distortion may be expected based on an individual finger, a device, an amount of incident light, sensor configurations, and so forth. Accordingly, a baseline amount of smudging may be determined. In some embodiments, the estimated fingerprint distortion may be determined during the fingerprint enrollment phase. For example, at the time a user is going through the enrollment process, the device may determine the geometry of the finger including specific configurations unique to the individual (e.g., geometric features, layout of ridges and valleys, scars, and so forth), an amount of pressure applied by the user, a manner in which the finger is moved from left to right to generate an impression of the fingerprint, and so forth. Also, for example, device and/or sensor specific properties may be retrieved and stored to generate the baseline. In some embodiments, a machine learning model (e.g., one or more models described herein, or a standalone distortion model) may be trained to predict the estimated fingerprint distortion. For example, the machine learning model may predict possible variations of an input fingerprint data. In some embodiments, training data may include a plurality of pairs of fingerprints and associated smudged fingerprints. The smudged fingerprints may be real data corresponding to fingerprint smudging (e.g., due to motion, pressure, perspiration, etc.), and/or synthetic data that simulate fingerprint smudging based on motion, pressure, perspiration, etc. Also, for example, one or more geometric transformations may be applied to the fingerprint data to determine the estimated fingerprint distortion. For example, the one or more geometric transformations may include rotations, translations, skews, contractions, expansions, and so forth, which may be applied to transform relative configurations of fingerprint features, such as ridges, pores, valleys, scars, and so forth.

In some embodiments, the estimated fingerprint distortion may be predicted by a machine learning model. For example, a machine learning model can be trained based on training data based on finger, device, sensor configurations, different light intensities, image degradations, and so forth, to determine the estimated fingerprint distortion. In some embodiments, the estimated fingerprint distortion may be determined during the fingerprint authentication phase. For example, statistical properties may be determined based on the fingerprint data, the motion data, and so forth, to determine the estimated fingerprint distortion. In some embodiments, a trained machine learning model may be used to infer the estimated fingerprint distortion during the fingerprint authentication phase.

Some embodiments involve detecting the fingerprint by the fingerprint matching component, wherein the detecting of the fingerprint comprises matching the reconstructed fingerprint with a stored fingerprint template. For example, a fingerprint matching component may include a fingerprint matching component 225 that may be configured to obtain the reconstructed fingerprint (e.g., modified fingerprint data corresponding to the reconstructed fingerprint) and compare the respective features of the reconstructed fingerprint and the stored fingerprint template. In some embodiments, a similarity threshold may be determined where the reconstructed fingerprint and the stored fingerprint template are determined to be a match when the respective feature sets are determined to be similar within the similarity threshold. In some embodiments, the fingerprint matching component 225 may determine a matching score indicative of a degree of matching. For example, a higher matching score may be indicative of a higher degree of matching between the reconstructed fingerprint and the stored fingerprint template. Also, for example, a lower matching score may be indicative of a lower degree of matching between the reconstructed fingerprint and the stored fingerprint template. In some embodiments, a matching threshold may be used to determine whether there is a match. For example, the matching threshold may be 70%, and a matching score that exceeds 70% may be determined to indicate a match.

FIG. 2C is an example block diagram depicting fingerprint detection by unsmudging an image using a machine learning model, in accordance with example embodiments. Some embodiments involve applying a machine learning model to perform the reconstruction of the unsmudged fingerprint. For example, image data from a single frame 230 and motion data from the finger motion detector 210 may be received by a machine learning based de-smudging model 235. The machine learning based de-smudging model 235 may be trained on various types of training data to reconstruct an unsmudged image. For example, the training data may involve a plurality of pairs of first data related to smudged fingerprints along with second data related to respective unsmudged versions of the fingerprints, and corresponding motion data that caused the smudging. The machine learning based de-smudging model 235 may be trained on such training data to receive fingerprint data for a smudged fingerprint and corresponding motion data to predict the unsmudged image. In some embodiments, conventional architectures may be used for the machine learning based de-smudging model 235. In some embodiments, machine learning based de-smudging model 235 may include an image enhancement neural network trained to enhance optical images by removing image distortions due to motion blur, pixel saturation, image compression artifacts, and so forth.

In some embodiments, the ASIC may be configured to accelerate inference for the machine learning based de-smudging model 235, such as one or more deep learning models. This is especially useful for fingerprint detection where real-time accurate detection has to be performed on the device. Performing inference on the device also enables enhanced security for the device as the data can be contained within the device instead of being transmitted to a cloud server hosting the machine learning model. In some embodiments, the TPU may be a whole system, including custom ASIC chips, board and interconnect, that is configured to accelerate both training and inference for the machine learning based de-smudging model 235. As previously described, the fingerprint matching component 225 may perform a matching of the reconstructed fingerprint and a stored fingerprint template.

FIG. 2D is an example block diagram depicting fingerprint detection using a machine learning based matching model, in accordance with example embodiments. Some embodiments involve applying a machine learning model to perform the reconstruction of the unsmudged fingerprint and the detecting of the fingerprint. For example, a machine learning model for de-smudging and matching 240 may be used to perform the operations of the unsmudging component 220 and fingerprint matching component 225. In some embodiments, the machine learning model for de-smudging and matching 240 may be two separate models. For example, a first model may share one or more features in common with the machine learning based de-smudging model 235, and a second model may be a machine learning based classifier that performs the operation of the fingerprint matching component 225. For example, a classifier may be trained to compare the reconstructed fingerprint with a plurality of fingerprint templates to determine whether there is a match. In some embodiments, a binary classifier may perform such a matching task.

In some embodiments, the machine learning model for de-smudging and matching 240 may be a standalone model that is trained to predict a match between the reconstructed fingerprint and a stored fingerprint template, based on the fingerprint data and the motion data, along with the estimated fingerprint distortion. In embodiments, where the estimated fingerprint distortion is computed by a machine learning model, such a model may operate independently, or as a part of the machine learning model for de-smudging and matching 240.

FIG. 2E is an example block diagram depicting fingerprint detection using a machine learning based matching and spoof detection model, in accordance with example embodiments. The term “spoof detection” as used herein generally refers to techniques to detect whether a falsified fingerprint is presented for verification. For example, a replica (e.g., engraved on a mold to create an impression of a fingerprint), or a digital print of a finger, or a portion thereof, may be created and presented for verification, and the anti-spoofing technique would be configured to detect that the fingerprint data does not correspond to an actual fingerprint. In some forms of spoofing, a sensor may be configured to modify the sensed data. In some aspects, machine learning based techniques may be used to synthesize human fingerprints for spoofing attacks.

Some anti-spoofing approaches may involve instructing the user to perform one or more of dragging their finger on the sensor, applying additional pressure, turning their finger in a specified manner, and so forth, to cause an intentionally smudged fingerprint. Such a smudged fingerprint may be compared with existing user data to detect spoofing. In some embodiments, smudged fingerprint may be desmudged and compared with additional existing user data to detect spoofing.

Some anti-spoofing approaches may also involve hardware based spoof detection based on properties of a fingerprint, such as, thermal properties, electrical charge values, skin resistance, pulse oximetry, and so forth. Also, for example, anti-spoofing approaches may involve software based spoof detection. For example, the one or more frames 215 may be processed to detect real-time distortions, perspiration changes, heat map changes, capacitive changes, and so forth.

Accordingly, some embodiments involve applying a machine learning model to perform the reconstruction of the unsmudged fingerprint, the detecting of the fingerprint, and to perform spoof detection. For example, the machine learning model for de-smudging, matching, and spoof detection 245 may be configured to combine the operations of the unsmudging component 220 and the fingerprint matching component 225 with anti-spoofing algorithms for spoof detection. The machine learning model for de-smudging, matching, and spoof detection 245 may be three separate models, or a combination of two or more models, each performing operations that combine at least two of unsmudging, matching, and anti-spoofing. In some embodiments, the machine learning model for de-smudging, matching, and spoof detection 245 may be a standalone model trained to perform unsmudging, matching, and anti-spoofing.

A spoof detection model may be trained based on a plurality of fingerprint data, thermal properties, electrical charge values, skin resistance, pulse oximetry, and so forth for real fingerprints, and for synthetically generated data, including data corresponding to physical molds that capture fingerprint impressions. The spoof detection model may be trained to detect a false fingerprint based on the training data. In some embodiments, the spoof detection model may be trained to perform spoof detection by comparing an intentionally smudged fingerprint (e.g., where the user is instructed to perform one or more actions such as dragging their finger on the sensor, applying additional pressure, turning their finger in a specified manner) with expected distortions of the user's fingerprint.

FIG. 2F is an example block diagram depicting fingerprint detection by unsmudging an image based on force detection, in accordance with example embodiments. Some embodiments involve detecting, by a pressure sensor, a pressure applied by the finger. Further, these embodiments involve measuring an amount of the applied pressure. The reconstruction of the unsmudged fingerprint is based on the measured amount of the applied pressure. For example, different individuals may apply different amounts of pressure on a fingerprint scanner. In some situations, the applied pressure may distort the fingerprint data (e.g., an image of a smudged fingerprint may appear smeared). Pressure data received from finger pressure detector 250 may be combined with motion data from fingerprint motion detector 210, fingerprint data from the one or more frames 215, and the estimated fingerprint distortion to determine the reconstructed image by unsmudging component 220.

In some embodiments, a machine learning model can be trained to reconstruct an image based on detecting an amount of pressure that may have been applied. For example, training data may include a plurality of pairs of smudged fingerprints with associated pressure amounts, and unsmudged versions of the fingerprints. A machine learning model may then be trained on such training data to receive a smudged image and pressure data, and predict an unsmudged version of the fingerprint. Such a machine learning model for pressure based unsmudging may be combined with the one or more machine learning models described herein (e.g., machine learning based de-smudging model 235, machine learning model for de-smudging and matching 240, and/or machine learning model for de-smudging, matching, and spoof detection 245).

Generally speaking, a user may be provided with controls allowing the user to make an election as to both if and when systems, programs, or features described herein may enable collection of user information (e.g., information about a user's fingerprint data, ethnicity, gender, social network, social contacts, or activities, a user's preferences, or a user's current location, and so forth), and if the user is sent content or communications from a server. In addition, certain data may be treated in one or more ways before it is stored or used, so that personal data is removed, secured, encrypted, and so forth. For example, a user's identity may be treated so that no user data can be determined for the user, or a user's geographic location may be generalized where location information is obtained (such as to a city, ZIP code, or state level), so that a particular location of a user cannot be determined. Thus, the user may have control over what information is collected about the user, how that information is used, what information is stored (e.g., on the user device, the server, etc.), and what information is provided to the user. In addition to user controls, in embodiments where user information is used for various aspects of fingerprint detection, spoof detection, etc., such user information is restricted to the user's device, and is not shared with a server, and/or with other devices. Also, for example, the user may have an ability to delete or modify any user information.

### Training Machine Learning Models for Generating Inferences/predictions

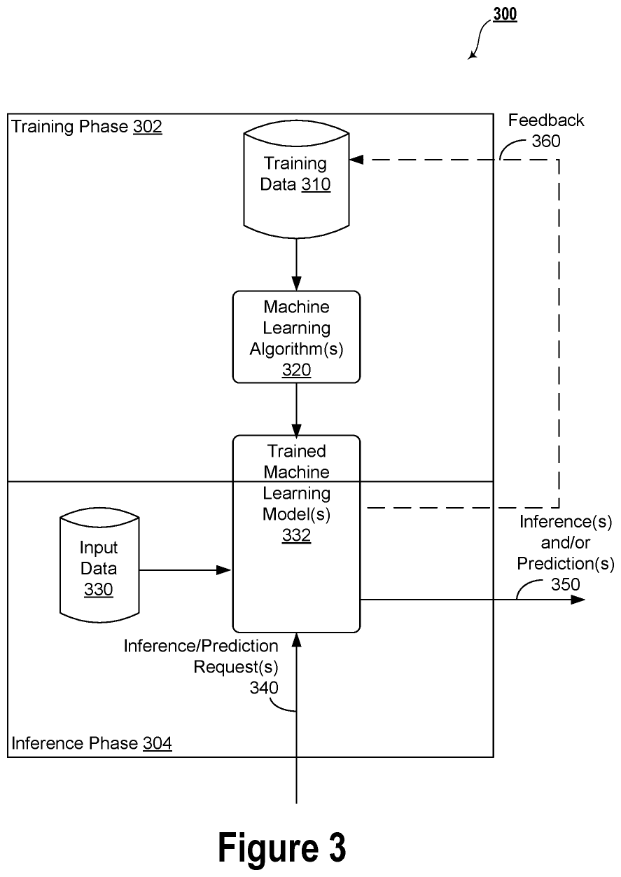

FIG. 3 shows diagram 300 illustrating a training phase 302 and an inference phase 304 of trained machine learning model(s) 332, in accordance with example embodiments. Some machine learning techniques involve training one or more machine learning algorithms on an input set of training data to recognize patterns in the training data and provide output inferences and/or predictions about (patterns in the) training data. The resulting trained machine learning algorithm can be termed as a trained machine learning model. For example, FIG. 3 shows training phase 302 where one or more machine learning algorithms 320 are being trained on training data 310 to become trained machine learning model 332. Then, during inference phase 304, trained machine learning model 332 can receive input data 330 (e.g., input fingerprint data, motion data, pressure data, estimated fingerprint distortion, and so forth) and one or more inference/prediction requests 340 (perhaps as part of input data 330) and responsively provide as an output one or more inferences and/or predictions 350 (e.g., predict an unsmudged version of a fingerprint, predict whether the input fingerprint data matches a stored fingerprint template, etc.).

As such, trained machine learning model(s) 332 can include one or more models of one or more machine learning algorithms 320. Machine learning algorithm(s) 320 may include, but are not limited to: an artificial neural network (e.g., a convolutional neural network, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 320 may be supervised or unsupervised, and may implement any suitable combination of online and offline learning. Supervised algorithms may include linear regression, decision trees, support vector machines, and/or a naïve Bayes classifier. Unsupervised algorithms may include hierarchical clustering, K-means clustering, self organizing maps, and/or hidden Markov models.

Various types of architectures may be deployed to perform one or more of the fingerprint detection and/or authentication operations described herein. For example, a ResNet architecture, a generative adversarial network (GAN), auto-encoders, recurrent neural network (RNN), and so forth may be used.

In some examples, machine learning algorithm(s) 320 and/or trained machine learning model(s) 332 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 320 and/or trained machine learning model(s) 332. In some examples, trained machine learning model(s) 332 can be trained, reside and execute to provide inferences on a particular computing device, and/or otherwise can make inferences for the particular computing device.

During training phase 302, machine learning algorithm(s) 320 can be trained by providing at least training data 310 as training input using unsupervised, supervised, semi-supervised, and/or weakly supervised learning techniques. Unsupervised learning involves providing a portion (or all) of training data 310 to machine learning algorithm(s) 320 and machine learning algorithm(s) 320 determining one or more output inferences based on the provided portion (or all) of training data 310. Supervised learning involves providing a portion of training data 310 to machine learning algorithm(s) 320, with machine learning algorithm(s) 320 determining one or more output inferences based on the provided portion of training data 310, and the output inference(s) are either accepted or corrected based on correct results associated with training data 310. In some examples, supervised learning of machine learning algorithm(s) 320 can be governed by a set of rules and/or a set of labels for the training input, and the set of rules and/or set of labels may be used to correct inferences of machine learning algorithm(s) 320.

Semi-supervised learning involves having correct labels for part, but not all, of training data 310. During semi-supervised learning, supervised learning is used for a portion of training data 310 having correct results, and unsupervised learning is used for a portion of training data 310 not having correct results. In some examples, machine learning algorithm(s) 320 and/or trained machine learning model(s) 332 can be trained using other machine learning techniques, including but not limited to, incremental learning and curriculum learning.

In some examples, machine learning algorithm(s) 320 and/or trained machine learning model(s) 332 can use transfer learning techniques. For example, transfer learning techniques can involve trained machine learning model(s) 332 being pre-trained on one set of data and additionally trained using training data 310. More particularly, machine learning algorithm(s) 320 can be pre-trained on data from one or more computing devices and a resulting trained machine learning model provided to a particular computing device, where the particular computing device is intended to execute the trained machine learning model during inference phase 304. Then, during training phase 302, the pre-trained machine learning model can be additionally trained using training data 310, where training data 310 can be derived from kernel and non-kernel data of the particular computing device. This further training of the machine learning algorithm(s) 320 and/or the pre-trained machine learning model using training data 310 of the particular computing device's data can be performed using either supervised or unsupervised learning. Once machine learning algorithm(s) 320 and/or the pre-trained machine learning model has been trained on at least training data 310, training phase 302 can be completed. The trained resulting machine learning model can be utilized as at least one of trained machine learning model(s) 332.

In particular, once training phase 302 has been completed, trained machine learning model(s) 332 can be provided to a computing device, if not already on the computing device. Inference phase 304 can begin after trained machine learning model(s) 332 are provided to the particular computing device.

During inference phase 304, trained machine learning model(s) 332 can receive input data 330 and generate and output one or more corresponding inferences and/or predictions 350 about input data 330. As such, input data 330 can be used as an input to trained machine learning model(s) 332 for providing corresponding inference(s) and/or prediction(s) 350 to kernel components and non-kernel components. For example, trained machine learning model(s) 332 can generate inference(s) and/or prediction(s) 350 in response to one or more inference/prediction requests 340. In some examples, trained machine learning model(s) 332 can be executed by a portion of other software. For example, trained machine learning model(s) 332 can be executed by an inference or prediction daemon to be readily available to provide inferences and/or predictions upon request. Input data 330 can include data from the particular computing device executing trained machine learning model(s) 332 and/or input data from one or more computing devices other than the particular computing device.

Input data 330 can include fingerprint data, motion data, and/or pressure data.

Inference(s) and/or prediction(s) 350 can include predicted unsmudged versions, results of anti-spoofing algorithms, a predicted output of a matching model, a predicted estimated fingerprint distortion, and/or other output data produced by trained machine learning model(s) 332 operating on input data 330 (and training data 310). In some examples, trained machine learning model(s) 332 can use output inference(s) and/or prediction(s) 350 as input feedback 360. Trained machine learning model(s) 332 can also rely on past inferences as inputs for generating new inferences.

A machine learning based de-smudging model 235, machine learning model for de-smudging and matching 240, and/or machine learning model for de-smudging, matching, and spoof detection 245, and so forth, can be examples of machine learning algorithm(s) 320. After training, the trained version of such neural networks can be examples of trained machine learning model(s) 332. In this approach, an example of inference/prediction request(s) 340 can be a request to predict whether an unsmudged version of a smudged fingerprint, predict results of anti-spoofing algorithms, predict an output of a matching model, predict an estimated fingerprint distortion, and a corresponding example of inferences and/or prediction(s) 350 can be an output indicating the respective outputs. In some examples, a given computing device can include a trained neural network (e.g., as illustrated in diagram 300), perhaps after training the neural network. Then, the given computing device can receive requests to predict whether an unsmudged version of a smudged fingerprint, predict results of anti-spoofing algorithms, predict an output of a matching model, predict an estimated fingerprint distortion, and so forth, and use the trained neural network to generate the prediction.

In some examples, two or more computing devices can be used to provide the prediction; e.g., a first computing device can generate and send requests to predict an unsmudged version of a smudged fingerprint, predict results of anti-spoofing algorithms, predict an output of a matching model, predict an estimated fingerprint distortion. Then, the second computing device can use the trained versions of neural networks, perhaps after training, to generate the prediction, and respond to the requests from the first computing device, upon reception of responses to the requests, the first computing device can provide the requested output (e.g., using a user interface and/or a display, a printed copy, an electronic communication, etc.).

### Example Data Network

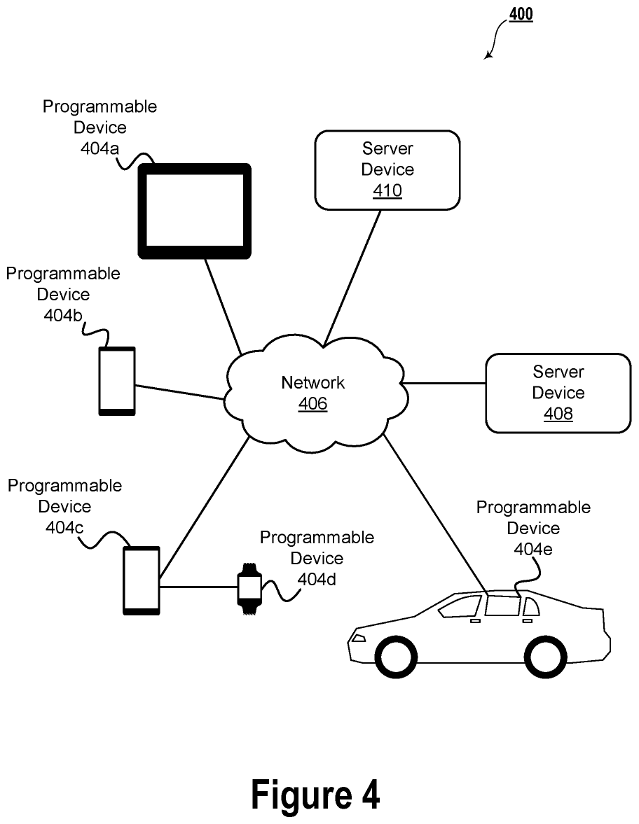

FIG. 4 depicts a distributed computing architecture 400, in accordance with example embodiments. Distributed computing architecture 400 includes server devices 408, 410 that are configured to communicate, via network 406, with programmable devices 404a, 404b, 404c, 404d, 404e. Network 406 may correspond to a local area network (LAN), a wide area network (WAN), a WLAN, a WWAN, a corporate intranet, the public Internet, or any other type of network configured to provide a communications path between networked computing devices. Network 406 may also correspond to a combination of one or more LANs, WANs, corporate intranets, and/or the public Internet.

Although FIG. 4 only shows five programmable devices, distributed application architectures may serve tens, hundreds, or thousands of programmable devices. Moreover, programmable devices 404a, 404b, 404c, 404d, 404e (or any additional programmable devices) may be any sort of computing device, such as a mobile computing device, desktop computer, wearable computing device, head-mountable device (HMD), network terminal, a mobile computing device, and so on. In some examples, such as illustrated by programmable devices 404a, 404b, 404c, 404e, programmable devices can be directly connected to network 406. In other examples, such as illustrated by programmable device 404d, programmable devices can be indirectly connected to network 406 via an associated computing device, such as programmable device 404c. In this example, programmable device 404c can act as an associated computing device to pass electronic communications between programmable device 404d and network 406. In other examples, such as illustrated by programmable device 404e, a computing device can be part of and/or inside a vehicle, such as a car, a truck, a bus, a boat or ship, an airplane, etc. In other examples not shown in FIG. 4, a programmable device can be both directly and indirectly connected to network 406.

Server devices 408, 410 can be configured to perform one or more services, as requested by programmable devices 404a-404e. For example, server device 408 and/or 410 can provide content to programmable devices 404a-404e. The content can include, but is not limited to, web pages, hypertext, scripts, binary data such as compiled software, images, audio, and/or video. The content can include compressed and/or uncompressed content. The content can be encrypted and/or unencrypted. Other types of content are possible as well.

As another example, server device 408 and/or 410 can provide programmable devices 404a-404e with access to software for database, search, computation, graphical, audio, video, World Wide Web/Internet utilization, and/or other functions. Many other examples of server devices are possible as well.

### Cloud-Based Servers

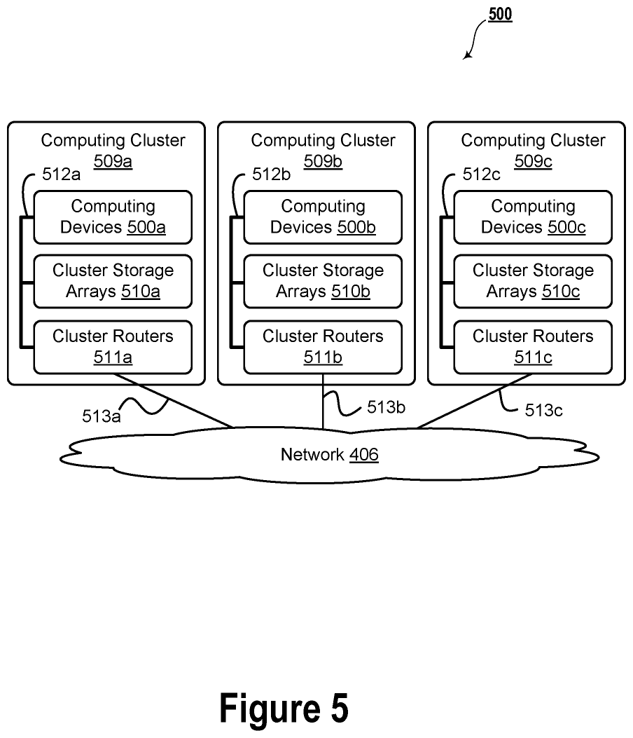

FIG. 5 depicts a network 406 of computing clusters 509a, 509b, 509c arranged as a cloud-based server system in accordance with an example embodiment. Computing clusters 509a, 509b, 509c can be cloud-based devices that store program logic and/or data of cloud-based applications and/or services; e.g., perform at least one function of and/or related to the neural networks, and/or method 600.

In some embodiments, computing clusters 509a, 509b, 509c can be a single computing device residing in a single computing center. In other embodiments, computing clusters 509a, 509b, 509c can include multiple computing devices in a single computing center, or even multiple computing devices located in multiple computing centers located in diverse geographic locations. For example, FIG. 5 depicts each of computing clusters 509a, 509b, and 509c residing in different physical locations.

In some embodiments, data and services at computing clusters 509a, 509b, 509c can be encoded as computer readable information stored in non-transitory, tangible computer readable media (or computer readable storage media) and accessible by other computing devices. In some embodiments, computing clusters 509a, 509b, 509c can be stored on a single disk drive or other tangible storage media, or can be implemented on multiple disk drives or other tangible storage media located at one or more diverse geographic locations.

FIG. 5 depicts a cloud-based server system in accordance with an example embodiment. In FIG. 5, functionality of the neural networks, and/or a computing device can be distributed among computing clusters 509a, 509b, 509c. Computing cluster 509a can include one or more computing devices 500a, cluster storage arrays 510a, and cluster routers 511a connected by a local cluster network 512a. Similarly, computing cluster 509b can include one or more computing devices 500b, cluster storage arrays 510b, and cluster routers 511b connected by a local cluster network 512b. Likewise, computing cluster 509c can include one or more computing devices 500c, cluster storage arrays 510c, and cluster routers 511c connected by a local cluster network 512c.

In some embodiments, each of computing clusters 509a, 509b, and 509c can have an equal number of computing devices, an equal number of cluster storage arrays, and an equal number of cluster routers. In other embodiments, however, each computing cluster can have different numbers of computing devices, different numbers of cluster storage arrays, and different numbers of cluster routers. The number of computing devices, cluster storage arrays, and cluster routers in each computing cluster can depend on the computing task or tasks assigned to each computing cluster.

In computing cluster 509a, for example, computing devices 500a can be configured to perform various computing tasks of a neural network, machine learning based de-smudging model 235, machine learning model for de-smudging and matching 240, and/or machine learning model for de-smudging, matching, and spoof detection 245, and/or a computing device. In one embodiment, the various functionalities of a neural network, machine learning based de-smudging model 235, machine learning model for de-smudging and matching 240, and/or machine learning model for de-smudging, matching, and spoof detection 245, and/or a computing device can be distributed among one or more of computing devices 500a, 500b, 500c. Computing devices 500b and 500c in respective computing clusters 509b and 509c can be configured similarly to computing devices 500a in computing cluster 509a. On the other hand, in some embodiments, computing devices 500a, 500b, and 500c can be configured to perform different functions.

In some embodiments, computing tasks and stored data associated with a neural network, machine learning based de-smudging model 235, machine learning model for de-smudging and matching 240, and/or machine learning model for de-smudging, matching, and spoof detection 245, and/or a computing device can be distributed across computing devices 500a, 500b, and 500c based at least in part on the processing requirements of a neural network, machine learning based de-smudging model 235, machine learning model for de-smudging and matching 240, and/or machine learning model for de-smudging, matching, and spoof detection 245, and/or a computing device, the processing capabilities of computing devices 500a, 500b, 500c, the latency of the network links between the computing devices in each computing cluster and between the computing clusters themselves, and/or other factors that can contribute to the cost, speed, fault-tolerance, resiliency, efficiency, and/or other design goals of the overall system architecture.

Cluster storage arrays 510a, 510b, 510c of computing clusters 509a, 509b, 509c can be data storage arrays that include disk array controllers configured to manage read and write access to groups of hard disk drives. The disk array controllers, alone or in conjunction with their respective computing devices, can also be configured to manage backup or redundant copies of the data stored in the cluster storage arrays to protect against disk drive or other cluster storage array failures and/or network failures that prevent one or more computing devices from accessing one or more cluster storage arrays.

Similar to the manner in which the functions of a neural network, machine learning based de-smudging model 235, machine learning model for de-smudging and matching 240, and/or machine learning model for de-smudging, matching, and spoof detection 245, and/or a computing device can be distributed across computing devices 500a, 500b, 500c of computing clusters 509a, 509b, 509c, various active portions and/or backup portions of these components can be distributed across cluster storage arrays 510a, 510b, 510c. For example, some cluster storage arrays can be configured to store one portion of the data of a neural network, machine learning based de-smudging model 235, machine learning model for de-smudging and matching 240, and/or machine learning model for de-smudging, matching, and spoof detection 245, and/or a computing device, while other cluster storage arrays can store other portion(s) of data of a neural network, machine learning based de-smudging model 235, machine learning model for de-smudging and matching 240, and/or machine learning model for de-smudging, matching, and spoof detection 245, and/or a computing device. Also, for example, some cluster storage arrays can be configured to store the data of a first neural network, while other cluster storage arrays can store the data of a second and/or third neural network. Additionally, some cluster storage arrays can be configured to store backup versions of data stored in other cluster storage arrays.

Cluster routers 511a, 511b, 511c in computing clusters 509a, 509b, 509c can include networking equipment configured to provide internal and external communications for the computing clusters. For example, cluster routers 511a in computing cluster 509a can include one or more internet switching and routing devices configured to provide (i) local area network communications between computing devices 500a and cluster storage arrays 510a via local cluster network 512a, and (ii) wide area network communications between computing cluster 509a and computing clusters 509b and 509c via wide area network link 513a to network 406. Cluster routers 511b and 511c can include network equipment similar to cluster routers 511a, and cluster routers 511b and 511c can perform similar networking functions for computing clusters 509b and 509b that cluster routers 511a perform for computing cluster 509a.

In some embodiments, the configuration of cluster routers 511a, 511b, 511c can be based at least in part on the data communication requirements of the computing devices and cluster storage arrays, the data communications capabilities of the network equipment in cluster routers 511a, 511b, 511c, the latency and throughput of local cluster networks 512a, 512b, 512c, the latency, throughput, and cost of wide area network links 513a, 513b, 513c, and/or other factors that can contribute to the cost, speed, fault-tolerance, resiliency, efficiency and/or other design criteria of the moderation system architecture.

### Example Methods

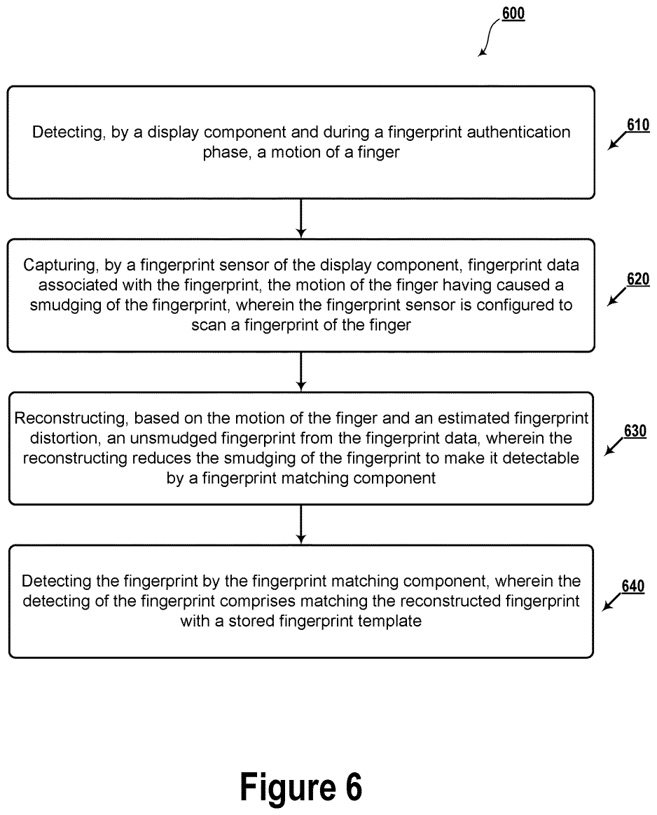

FIG. 6 illustrates a method 600, in accordance with example embodiments. Method 600 may include various blocks or steps. The blocks or steps may be carried out individually or in combination. The blocks or steps may be carried out in any order and/or in series or in parallel. Further, blocks or steps may be omitted or added to method 600.

The blocks of method 600 may be carried out by various elements of computing device 100 as illustrated and described in reference to FIG. 1.

Block 610 involves detecting, by a display component and during a fingerprint authentication phase, a motion of a finger.

Block 620 involves capturing, by a fingerprint sensor of the display component, fingerprint data associated with the fingerprint, the motion of the finger having caused a smudging of the fingerprint, wherein the fingerprint sensor is configured to scan a fingerprint of the finger.

Block 630 involves reconstructing, based on the motion of the finger and an estimated fingerprint distortion, an unsmudged fingerprint from the fingerprint data, wherein the reconstructing reduces the smudging of the fingerprint to make it detectable by a fingerprint matching component.

Block 640 involves detecting the fingerprint by the fingerprint matching component, wherein the detecting of the fingerprint comprises matching the reconstructed fingerprint with a stored fingerprint template.

Some embodiments involve applying a machine learning model to perform the reconstruction of the unsmudged fingerprint. Some embodiments involve training the machine learning model to predict a plurality of unsmudged variations of a given scanned fingerprint.

Some embodiments involve applying a machine learning model to perform the reconstruction of the unsmudged fingerprint and the detecting of the fingerprint.

Some embodiments involve applying a machine learning model to perform the reconstruction of the unsmudged fingerprint, the detecting of the fingerprint, and to perform spoof detection.

Some embodiments involve detecting, by a pressure sensor, a pressure applied by the finger. Further, these embodiments involve measuring an amount of the applied pressure. The reconstruction of the unsmudged fingerprint is based on the measured amount of the applied pressure.

In some embodiments, the detecting of the motion of the finger is based on respective pixel values of one or more pixels in a pixel array of an image of the fingerprint. In some embodiments, the one or more pixels in the pixel array are dedicated for motion detection.

In some embodiments, the detecting of the motion of the finger is performed using an application specific integrated circuit (ASIC) of the device.

In some embodiments, the display component includes a touch sensitive display panel, the fingerprint sensor may be an under display fingerprint sensor (UDFPS), and the method involves determining a heat map indicative of motion at or near the touch sensitive display panel. The detecting of the motion of the finger may be based on the heat map.

In some embodiments, the device includes a heat sensor configured to detect thermal activity at or near the device, and the method involves determining a heat map based on the detected thermal activity. The detecting of the motion of the finger may be based on the heat map.

In some embodiments, the fingerprint sensor may be a capacitive fingerprint sensor. The detecting of the motion of the finger may be based on a capacitive region of the display component.

Some embodiments involve determining an optical flow based on one or more images of the fingerprint. The detection of the motion of the finger may be based on the optical flow.

In some embodiments, the stored fingerprint template may be predetermined during a fingerprint enrollment phase of the fingerprint, wherein the fingerprint enrollment phase occurs prior to the fingerprint authentication phase.

In some embodiments, the estimated fingerprint distortion may be determined during the fingerprint enrollment phase.

In some embodiments, the estimated fingerprint distortion may be determined during the fingerprint authentication phase.

In some embodiments, the estimated fingerprint distortion may be based on a normalized amount of smudging based on a plurality of users, a plurality of devices, or both.

In some embodiments, the estimated fingerprint distortion may be predicted by a machine learning model.

In some embodiments, the device may be a mobile computing device.

In some embodiments, the reconstruction of the unsmudged fingerprint and the detecting of the fingerprint may be performed at the device.

In some embodiments, the estimated fingerprint distortion may be indicative of a baseline amount of smudging.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

1. A device comprising:
a display component comprising a fingerprint sensor configured to scan a fingerprint of a finger; and
one or more processors operable to:
detect, during a fingerprint authentication phase, a motion of the finger;
capture, by a fingerprint sensor of the display component, fingerprint data associated with the fingerprint, the motion of the finger having caused a smudging of the fingerprint;
reconstruct, based on the motion of the finger and an estimated fingerprint distortion, an unsmudged fingerprint from the fingerprint data, wherein the reconstructing reduces the smudging of the fingerprint to make it detectable by a fingerprint matching component; and
detect the fingerprint by the fingerprint matching component, wherein the detecting of the fingerprint comprises matching the reconstructed fingerprint with a stored fingerprint template.

2. The device of claim 1, wherein the processors are further operable to:
apply a machine learning model to perform the reconstruction of the unsmudged fingerprint.

3. The device of claim 2, wherein the processors are further operable to:
train the machine learning model to predict a plurality of unsmudged variations of a given scanned fingerprint.

4. The device of claim 1, wherein the processors are operable to:
apply a machine learning model to perform the reconstruction of the unsmudged fingerprint and the detecting of the fingerprint.

5. The device of claim 1, wherein the processors are further operable to:
applying a machine learning model to perform the reconstruction of the unsmudged fingerprint, the detecting of the fingerprint, and to perform spoof detection.

6. The device of claim 1, wherein the processors are further operable to:
detecting, by a pressure sensor, a pressure applied by the finger; and
measuring an amount of the applied pressure,
wherein the reconstruction of the unsmudged fingerprint is based on the measured amount of the applied pressure.

7. The device of claim 1, wherein the processors are operable to detect the motion of the finger based on respective pixel values of one or more pixels in a pixel array of an image of the fingerprint.

8. The device of claim 7, wherein the one or more pixels in the pixel array are dedicated for motion detection.

9. The device of claim 1, wherein the processors are operable to detect the motion of the finger using an application specific integrated circuit (ASIC) of the device.

10. The device of claim 1, wherein the display component comprises a touch sensitive display panel, wherein the fingerprint sensor is an under display fingerprint sensor (UDFPS), and wherein the processors are further operable to:
determine a heat map indicative of motion at or near the touch sensitive display panel,
wherein the processors are operable to detect the motion of the finger based on the heat map.

11. The device of claim 1, further comprising a heat sensor configured to detect thermal activity at or near the device, and wherein the processors are further operable to:
determine a heat map based on the detected thermal activity,
wherein the processors are operable to detect the motion of the finger based on the heat map.

12. The device of claim 1, wherein the fingerprint sensor is a capacitive fingerprint sensor, and wherein the processors are operable to detect the motion of the finger based on a capacitive region of the display component.

13. The device of claim 1, wherein the processors are further operable to:
determine an optical flow based on one or more images of the fingerprint,
wherein the processors are operable to detect the motion of the finger based on the optical flow.

14. The device of claim 1, the stored fingerprint template has been predetermined during a fingerprint enrollment phase of the fingerprint, wherein the fingerprint enrollment phase occurs prior to the fingerprint authentication phase.

15. (canceled)

16. The device claim 1, wherein the estimated fingerprint distortion is determined during the fingerprint authentication phase.

17. The device of claim 1, wherein the estimated fingerprint distortion is based on a normalized amount of smudging based on a plurality of users, a plurality of devices, or both.

18. The device of claim 1, wherein the estimated fingerprint distortion is predicted by a machine learning model.

19. (canceled)

20. The device of claim 1, wherein the reconstruction of the unsmudged fingerprint and the detecting of the fingerprint are performed at the device.

21. (canceled)

22. A computer-implemented method, comprising:
detecting, by a display component and during a fingerprint authentication phase, a motion of a finger;
capturing, by a fingerprint sensor of the display component, fingerprint data associated with the fingerprint, the motion of the finger having caused a smudging of the fingerprint, wherein the fingerprint sensor is configured to scan a fingerprint of the finger;
reconstructing, based on the motion of the finger and an estimated fingerprint distortion, an unsmudged fingerprint from the fingerprint data, wherein the reconstructing reduces the smudging of the fingerprint to make it detectable by a fingerprint matching component; and detecting the fingerprint by the fingerprint matching component, wherein the detecting of the fingerprint comprises matching the reconstructed fingerprint with a stored fingerprint template.

23. A non-transitory computer-readable medium, having stored thereon program instructions that, when executed by one or more processors of a computing device, cause the computing device to:
detect, via a display component and during a fingerprint authentication phase, a motion of a finger;
capture, via a fingerprint sensor of the display component, fingerprint data associated with the fingerprint, the motion of the finger having caused a smudging of the fingerprint, wherein the fingerprint sensor is configured to scan a fingerprint of the finger;
reconstruct, based on the motion of the finger and an estimated fingerprint distortion, an unsmudged fingerprint from the fingerprint data, wherein the reconstructing reduces the smudging of the fingerprint to make it detectable by a fingerprint matching component; and
detect the fingerprint by the fingerprint matching component, wherein the detecting of the fingerprint comprises matching the reconstructed fingerprint with a stored fingerprint template.
